(19) United States
(12) Patent Application Publication
(10) Pub. No.: US 2024/0169999 A1
(43) Pub. Date: May 23, 2024

(54) SPEECH SIGNAL PROCESSING APPARATUS, SPEECH SIGNAL REPRODUCTION SYSTEM AND METHOD FOR OUTPUTTING A DE-EMOTIONALIZED SPEECH SIGNAL

(71) Applicant: Fraunhofer-Gesellschaft zur Förderung der angewandten Forschung e.V., München (DE)

(72) Inventors: Jens-Ekkehart APPELL, Ilmenau (DE); Jan RENNIES-HOCHMUTH, Ilmenau (DE); Matthias BRUCKE, Rastede (DE)

(21) Appl. No.: 18/429,601

(22) Filed: Feb. 1, 2024

Related U.S. Application Data
(63) Continuation of application No. PCT/EP2022/071577, filed on Aug. 1, 2022.

(30) Foreign Application Priority Data
Aug. 2, 2021 (DE) 10 2021 208 344.7

(51) Int. Cl. G10L 21/0208; G10L 15/04; G10L 25/30; G10L 25/63

(52) U.S. Cl. CPC G10L 21/0208; G10L 15/04; G10L 25/30; G10L 25/63

(57) ABSTRACT

A speech signal processing apparatus for outputting a de-emotionalized speech signal in real time or time-shifted is described. The apparatus includes a speech signal detection apparatus for detecting speech signal comprising at least one piece of emotion information and at least one piece of word information, an analysis apparatus for analyzing the speech signal with respect to the at least one piece of emotion information and the at least one piece of word information, a processing apparatus for dividing the speech signal into the at least one piece of word information and into the at least one piece of emotion information and for processing the speech signal; and a coupling apparatus and/or a reproduction apparatus for reproducing the speech signal as de-emotionalized speech signal comprising the at least one piece of emotion information converted into a further piece of word information and/or the at least one piece of word information.

### CROSS-REFERENCE TO RELATED APPLICATIONS

This application is a continuation of copending International Application No. PCT/EP2022/071577, filed Aug. 1, 2022, which is incorporated herein by reference in its entirety, and additionally claims priority from German Application No. 10 2021 208 344.7, filed Aug. 2, 2021, which is also incorporated herein by reference in its entirety.

The present invention relates to a speech signal processing apparatus for outputting a de-emotionalized speech signal in real time or after a time period, a speech signal reproduction system as well as a method for outputting a de-emotionalized speech signal in real time or after a time period and a computer-readable storage medium.

### BACKGROUND OF THE INVENTION

So far, no technical system is known that solves a significant problem of speech-based communication. The problem is that a spoken language is enriched with so-called suprasegmental features (SF), such as intonation, speaking speed, duration of pauses in speech, intensity or volume, etc. Different dialects of a language can also result in a phonetic sound of the spoken language that can provide comprehension problems for outsiders. One example is the north German dialect compared to the south German dialect. Suprasegmental features of language are a phonological characteristic that phonetically indicates feelings, impairments and individual specific features (see also Wikipedia regarding “suprasegmentales Merkmal”). These SF in particular transmit emotions but also aspects that change the content to the listener. However, not all people are able to deal with these SF in a suitable manner or to interpret the same correctly.

For example, for people with autism, it is significantly more difficult to access emotions of other people. Here, for simplicity reasons, the term autism is used in a very general manner. Actually, there are very different forms and degrees of autism (also a so-called autism spectrum). However, for the understanding of the invention, this does not necessarily have to be differentiated. Emotions, but also changes of content that are embedded in language via SF are frequently not discernable for them and/or are confusing for them, up to their refusal to communicate via language and the usage of alternatives, such as written language or picture cards.

Cultural differences or communication in a foreign language can also limit the information gain from SF or can result in misinterpretations. Also, the situation where a speaker is located (e.g. firefighters directly at the source of the fire) can result in a very emotionally charged communication (e.g. with the operational command), which makes coping with the situation more difficult. A similar problem exists with a particularly complex formulated language that is only difficult to comprehend for people with cognitive impairment, where the SF possibly make the comprehension even more difficult.

The problem has been confronted in different ways or it simply remained unsolved. For autism, different alternative ways of communication are used (merely text-based interaction, e.g. by writing messages on a tablet, usage of picture cards, . . . ). For cognitive impairment, partly the so-called “simple language” is used, for example in written notifications or specific news programs. A solution that changes language spoken in real time such that the same is comprehensible to the above target groups is not known so far.

### SUMMARY

According to an embodiment, a speech signal processing apparatus for outputting a de-emotionalized speech signal may have: a speech signal detection apparatus configured to detect a speech signal including at least one piece of emotion information and at least one piece of word information; an analysis apparatus including a neuronal network or artificial intelligence configured to analyze the speech signal with respect to the at least one piece of emotion information and the at least one piece of word information, a processing apparatus including a neuronal network or artificial intelligence configured to divide the speech signal into the at least one piece of word information and into the at least one piece of emotion information and to process the speech signal, wherein the at least one piece of emotion information is transcribed into a further piece of word information; and a coupling apparatus and/or a reproduction apparatus configured to reproduce the speech signal as de-emotionalized speech signal including the at least one piece of emotion information converted into the further piece of word information and the at least one piece of word information.

According to another embodiment, a method for outputting a de-emotionalized speech signal in real time or after a time period may have the steps of: detecting a speech signal including at least one piece of word information and at least one piece of emotion information; analyzing the speech signal with respect to the at least one piece of word information and with respect to the at least one piece of emotion information; dividing the speech signal into the at least one piece of word information and into the at least one piece of emotion information and processing the speech signal; reproducing the speech signal as de-emotionalized speech signal including the at least one piece of emotion information converted into a further piece of word information and including the at least one piece of word information.

Another embodiment may have a non-transitory digital storage medium having a computer program stored thereon to perform the inventive method for outputting a de-emotionalized speech signal in real time or after a time period when said computer program is run by a computer.

It is the core idea of the present invention to provide a transformation of a speech signal that is provided with SF and possibly formulated in a particularly complex manner into a speech signal that is completely or partly freed from SF features and possibly formulated in a simplified manner for supporting speech-based communication for certain listener groups, individual listeners or specific listening situations. The suggested solution is a speech signal processing apparatus, a speech signal reproduction system and a method that frees a speech signal from individual or several SF offline or in real time and offers this freed signal to the listener, or stores the same in a suitable manner for later listening. Here, the elimination of emotions can be a significant feature.

A speech signal processing apparatus for outputting a de-emotionalized speech signal in real time or after a time period is suggested. The speech signal processing apparatus includes a speech signal processing apparatus for detecting a speech signal. The speech signal includes at least one piece of emotion information and at least one piece of word information. Additionally, the speech signal processing apparatus includes an analysis apparatus for analyzing the speech signal with respect to the at least one piece of emotion information and the at least one piece of word information, a processing apparatus for dividing the speech signal into the at least one piece of word information and the at least one piece of emotion information; and a coupling apparatus and/or a reproduction apparatus for reproducing the speech signal as de-emotionalized speech signal including the at least one piece of emotion information converted into a further piece of word information and/or the at least one piece of word information. The at least one piece of word information can also be considered as at least one first piece of word information. The further piece of word information can be considered as a second piece of word information. Here, the piece of emotion information is transcribed into the second piece of word information as long as the piece of emotion information is transcribed into a piece of word information. Here, the term information is used synonymously with the term signal. The emotion information includes a suprasegmental feature. The at least one piece of emotion information includes one or several suprasegmental features. As suggested, the detected emotion information is either not reproduced at all or the emotion information is reproduced together with the original word information also as a first and second piece of word information. Thereby, a listener can understand the emotion information without any problems as long as the emotion information is reproduced as further word information. However, it is also possible, if the emotion information does not provide any significant information contribution, to subtract the emotion information from the speech signal and to only reproduce the original (first) piece of word information.

Here, the analysis apparatus could also be referred to as a recognition system, as the analysis apparatus is configured to recognize which portion of the detected speech signal describes word information and which portion of the detected speech signal describes emotion information. Further, the analysis apparatus can be configured to identify different speakers. Here, a de-emotionalized speech signal means a speech signal that is completely or partly freed from emotions. A de-emotionalized speech signal therefore includes only in particular first and/or second pieces of word information, wherein one or also several pieces of word information can be based on a piece of emotion information. For example, speech synthesis with a robot voice can result in complete exemption of emotions. For example, it is also possible to generate an angry robot voice. Partial reduction of emotions in the speech signal could be performed by direct manipulation of the speech audio material, such as by reducing level dynamics, reducing or limiting the fundamental frequency, changing the speech rate, changing the spectral content of the language and/or changing the prosody of the speech signal, etc.

The speech signal can also originate from an audio stream (audio data stream), e.g. television, radio, podcast, audio book. A speech signal detection apparatus in the closer sense could be considered as a “microphone”. Additionally, the speech signal detection apparatus could be considered as an apparatus that allows the usage of a general speech signal, for example from the above-stated sources.

Technical implementation of the suggested speech signal processing apparatus is based on an analysis of the input speech (speech signal) by an analysis apparatus, such as a recognition system (e.g. neuronal network, artificial intelligence, etc.), which has either learned the transcription into the target signal based on training data (end-to-end transcription) or rule-based transcription based on detected emotions which can themselves also be taught inter-individually or intra-individually to the recognition system.

Two or more speech signal processing apparatuses form a speech signal reproduction system. With a speech signal reproduction system, for example two or several listeners can be provided in real time with individually adapted de-emotionalized speech signals by a speaker providing speech signal. One example for this is lessons at a school or a tour through a museum with a tour guide, etc.

A further aspect of the present invention relates to a method for outputting a de-emotionalized speech signal in real time or after a time period. The method includes detecting a speech signal including at least one piece of word information and at least one piece of emotion information. A speech signal could be provided, for example, in real time by a lecturer in front of a group of listeners. The method further includes analyzing the speech signal with respect to the at least one piece of word information and with respect to the at least one piece of emotion information. The speech signal has to be detected with respect to its word information and its emotion information. The at least one piece of emotion information includes at least one suprasegmental feature that is to be transcribed into a further, in particular second piece of word information. Consequently, the method includes dividing the speech signal into the at least one piece of word information and into the at least one piece of emotion information and reproducing the speech signal as de-emotionalized speech signal, which includes the at least one piece of emotion information transcribed into a further word information and/or includes the at least one piece of word information.

For redundancy reasons, the explanations of terms with respect to the speech signal processing apparatus are not repeated. However, it is obvious that these explanations of terms analogously apply to the method and vice versa.

A core of the technical teaching described herein is that the information included in the SF (e.g. also the emotions) is recognized and that this information is inserted into the output signal in a spoken or written or pictorial manner. For example: a speaker says in a very excited manner “What a cheek that you deny access to me” could be transcribed into “I am very upset since it is a cheek that . . . ”.

One advantage of the technical teaching disclosed herein is that the speech signal processing apparatus/the method is individually matched to a user by identifying SF that are very disturbing for the user. This can be particularly important to people with autism as the individual severity and sensitivity with respect to SF can vary strongly. Determining the individual sensitivity can take place, for example, via a user interface by direct feedback or inputs of closely related people (e.g. parents) or by neurophysiological measurements, such as heartrate variability (HRV) or EEG. Neurophysiological measurements have been identified in scientific studies as a marker for perception of stress, exertion or positive/negative emotions caused by acoustic signals and can therefore basically be used for determining connections between SF and individual impairment in connection with the above-mentioned detector systems. After determining such a connection, the speech signal processing apparatus/the method can reduce or suppress the respective particularly disturbing SF proportions, while other SF proportions are not processed or processed in a different manner.

If the speech is not manipulated directly, but the speech is generated “artificially” (i.e. in an end-to-end method) without SF, the tolerated SF proportions can be added to this SF-free signal based on the same information and/or specific SF proportions can be generated which can support comprehension.

A further advantage of the technical teaching disclosed herein is that a reproduction of the de-emotionalized signal can be adapted to the auditory needs of a listener, in addition to the modification of the SF portions. It is, for example, known that people with autism have specific requirements regarding a good speech comprehensibility and are distracted easily from the speech information, for example by disturbing noises included in the recording. This can be reduced, for example, by a disturbing noise reduction, possibly individualized in its extent. In addition, individual listening impairments can be compensated when processing the speech signals (e.g. by nonlinear frequency-dependent amplifications as used in hearing aids) or the speech signal reduced by the SF portions is additionally processed to a generalized, not individually matched processing, which, for example, increases the clarity of the voice or suppresses disturbing noises.

A specific potential of the present technical teaching is the usage in the communication with persons with autism and people speaking in a foreign language.

The approach of an automated transcription of a speech signal described herein into a new speech signal freed from FS proportions or amended in its FS proportions and/or mapping the information included in the SF proportions as regards to content, which is real-time capable, eases and improves the communication with persons with autism and/or persons speaking a foreign language or with persons in an emotionally charged communication scenario (fire brigade, military, alarm activation) or with persons having cognitive impairments.

### BRIEF DESCRIPTION OF THE DRAWINGS

Embodiments of the present invention will be detailed subsequently referring to the appended drawings, in which:

FIG. 1 is a schematic illustration of a speech signal processing apparatus;

FIG. 2 is a schematic illustration of a speech signal reproduction system; and

FIG. 3 is a flow diagram of a suggested method.

### DETAILED DESCRIPTION OF THE INVENTION

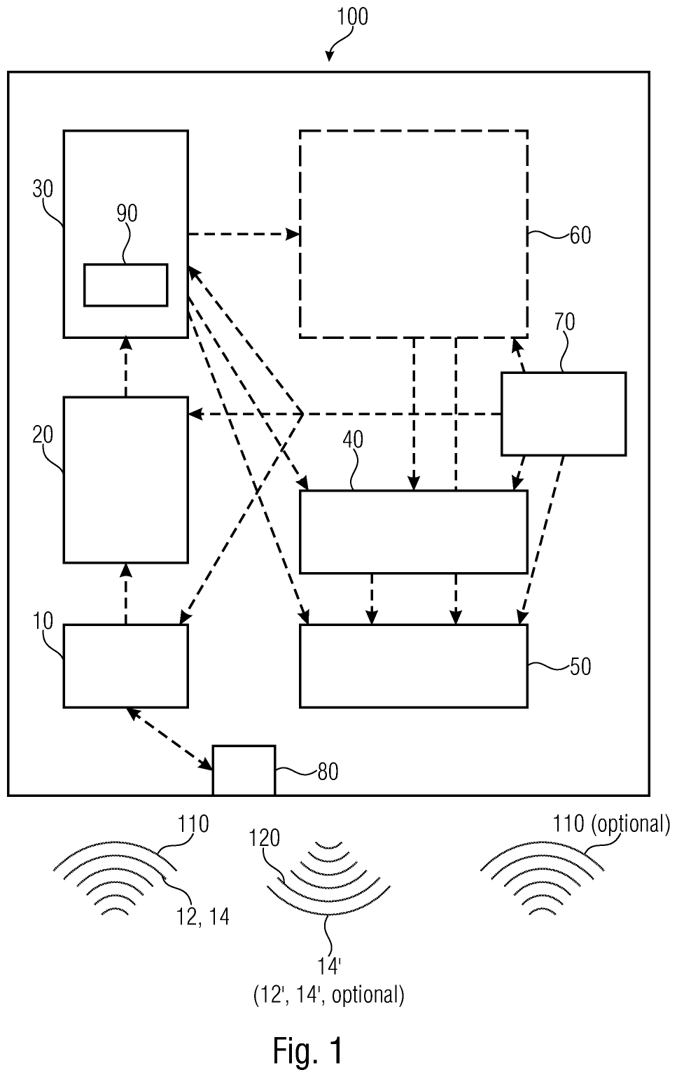

Individual aspects of the invention described herein will be described below in FIGS. 1 to 3. When combining FIGS. 1 to 3, the principle of the present invention will be illustrated. In the present application, the same reference numbers relate to the same or equal elements, wherein not all reference numbers are shown again in all figures as long as the same repeat themselves.

All explanations of terms provided in this application can be applied both to the suggested speech signal reproduction system and the suggested method. The explanations of terms are not continuously repeated in order to prevent redundancies as far as possible.

FIG. 1 shows a speech signal processing apparatus 100 for outputting a de-emotionalized speech signal 120 in real time or after a time period. The speech signal processing apparatus 100 includes a speech signal detection apparatus 10 for detecting a speech signal 110 that includes at least one piece of emotion information 12 and at least one piece of word information 14. Additionally, the speech signal processing apparatus 100 includes an analysis apparatus 20 for analyzing the speech signal 110 with respect to the at least one piece of emotion information 12 and the at least one piece of word information 14. The analysis apparatus 20 could also be referred to as recognition system as the analysis apparatus is configured to recognize at least one piece of emotion information 12 and at least one piece of word information 14 of a speech signal 110 when the speech signal 110 includes at least one piece of emotion information 12 and at least one piece of word information 14. Further, the speech signal processing apparatus 100 includes a processing apparatus 30 for dividing the speech signal 110 into the at least one piece of word information 14 and the at least one piece of emotion information 12, and for processing the speech signal 110. When processing the speech signal 110, the piece of emotion information 12 is transcribed into a further, in particular second piece of word information 14′. A piece of emotion information 12 is, for example, a suprasegmental feature. Additionally, the speech signal processing apparatus 100 includes a coupling apparatus 40 and/or a reproduction apparatus 50 for reproducing the speech signal 110 as de-emotionalized speech signal 120, which converts the at least one piece of emotion information 12 into a further piece of word information 14′, and/or includes the at least one piece of word information 14. The piece of emotion information 12 can be reproduced as further piece of word information 14′ in real time to a user. Thereby, comprehension problems of the user can be compensated, in particularly prevented.

When learning a foreign language, for understanding a dialect, or for people with cognitive limitations, the suggested speech signal processing apparatus 100 can ease communication in an advantageous manner.

The speech signal processing apparatus 100 includes a storage apparatus 60 storing the de-emotionalized speech signal 120 and/or the detected speech signal 110 to reproduce the de-emotionalized speech signal 120 at any time, in particular to reproduce the stored speech signal 110 as de-emotionalized speech signal 120 at several times and not only a single time. The storage apparatus 60 is optional. In the storage apparatus 60, both the original speech signal 110 that has been detected as well as the already de-emotionalized speech signal 120 can be stored. Thereby, the de-emotionalized speech signal 120 can be reproduced, in particular replayed, repeatedly. Thus, the user can first have the de-emotionalized speech signal 120 reproduced in real time and can have the de-emotionalized speech signal 120 reproduced again at a later time. For example, a user could be a student at school having the de-emotionalized speech signal 120 reproduced in situ. When reworking the teaching material outside the school, i.e. at a later time, the student could have the de-emotionalized speech signal 120 reproduced again when needed. Thereby, the speech signal processing apparatus 100 can support a learning success for the user.

Storing the speech signal 110 corresponds to storing a detected original signal. The stored original signal can then be reproduced later in a de-emotionalized manner. The de-emotionalization process can take place later and can then be reproduced in real time of the de-emotionalization process. Analyzing and processing of the speech signal 110 can take place later.

Further, it is possible to de-emotionalize the speech signal 110 and to store the same as de-emotionalized signal 120. Then, the stored de-emotionalized signal 120 can be reproduced later, in particular repeatedly.

Depending on the storage capacity of the storage apparatus 60, it is further possible to store the speech signal 110 and the allocated de-emotionalized signal 120 to reproduce both signals later. This can be useful, for example, when individual user settings are to be amended after the detected speech signal and the subsequently stored de-emotionalized signal 120. It is possible that a user is not satisfied with the speech signal 120 de-emotionalized in real time, such that post-processing of the de-emotionalized signal 120 by the user or another person seems to be useful so that a speech signal detected in future can be de-emotionalized considering the post-processing of the de-emotionalized signal 120. Thereby, de-emotionalizing a speech signal 120 to the individual needs of a user can be adapted afterwards.

The processing apparatus 30 is configured to recognize speech information 14 included in the emotion information 12 and to translate the same into a de-emotionalized speech signal 120 and to pass it on to the reproduction apparatus 50 for reproduction by the reproduction apparatus 50 or passes the same on to the coupling apparatus 40 that is configured to connect to an external reproduction apparatus (not shown), in particular a smartphone or a tablet, to transmit the de-emotionalized signal 120 for reproduction of the same. Thus, it is possible that one and the same speech signal reproduction apparatus 100 reproduces the de-emotionalized signal 120 by means of an integrated reproduction apparatus 50 of the speech signal reproduction apparatus 100, or that the speech signal reproduction apparatus 100 transmits the de-emotionalized signal 120 to an external reproduction apparatus 50 by means of a coupling apparatus 40 to reproduce the de-emotionalized signal 120 at the external reproduction apparatus 50. When transmitting the de-emotionalized signal 120 to an external reproduction apparatus 50, it is possible to transmit the de-emotionalized signal 120 to a plurality of external reproduction apparatuses 50.

Additionally, it is possible that the speech signal 110 is transmitted to a plurality of external speech signal processing apparatuses 100 by means of the coupling apparatus, wherein each speech signal processing apparatus 100 de-emotionalizes the received speech signal 100 according to the individual needs of the respective user of the speech signal processing apparatus 100, and reproduces the same for the respective user as de-emotionalized speech signal 120. For this, for example in a school class, a de-emotionalized signal 120 can be reproduced for each student adapted to his or her needs. Thereby, a learning success of a school class of students can be improved by meeting individual needs.

The analysis apparatus 20 is configured to analyze a disturbing noise and/or a piece of emotion information 12 in the speech signal 110 and the processing apparatus 30 is configured to remove the analyzed disturbing noise and/or the emotion information 12 from the speech signal 110. As for example shown in FIG. 1, the analysis apparatus 20 and the processing apparatus 30 can be two different apparatuses. However, it is also possible that the analysis apparatus 20 and the processing apparatus 30 are provided by a single apparatus. The user using the speech signal processing apparatus 100 in order to have a de-emotionalized speech signal 120 reproduced can mark a noise as disturbing noise according to his or her individual needs, which can then be automatically removed by the speech signal processing apparatus 100. Additionally, the processing apparatus can remove piece of emotion information 12 providing no essential contribution to a piece of word information 14 from the speech signal 110. The user can mark piece of emotion information 12 providing no significant contribution to the piece of word information 14 as such according to his or her needs.

As shown in FIG. 1, the different apparatuses 10, 20, 30, 40, 50, 60 can be in communicative exchange (see dotted arrows). Each other useful communicative exchange of the different apparatuses 10, 20, 30, 40, 50, 60 is also possible.

The reproduction apparatus 50 is configured to reproduce the de-emotionalized speech signal 120 without the piece of emotion information 12, or with the piece of emotion information 12 that is transcribed into a further piece of word information 14′ and/or with a newly impressed piece of emotion information 12′. The user can decide or mark according to his or her individual needs, which type of impressed emotion information 12′ can improve comprehension of the de-emotionalized signal 120 when reproducing the de-emotionalized signal 120. Additionally, the user can decide or mark, which type of emotion information 12 is to be removed from the de-emotionalized signal 120. This can also improve comprehension of the de-emotionalized signal 120 for the user. Additionally, the user can decide or mark which type of emotion information 12 is to be transcribed as further, in particular second piece of word information 14′, to incorporate the same into the de-emotionalized signal 120. The user can therefore influence the de-emotionalized signal 120 according to his or her individual needs such that the de-emotionalized signal 120 is comprehensible for user to a maximum extent.

The reproduction apparatus 50 includes a loudspeaker and/or a display to reproduce the de-emotionalized speech signal 120, in particular in simplified language, by an artificial voice and/or by displaying a computer-written text and/or by generating and displaying picture card symbols and/or by animation of sign language. The reproduction apparatus 50 can have any configuration preferred by the user. The de-emotionalized speech signal 120 can be reproduced at the reproduction apparatus 50 such that the user comprehends the de-emotionalized speech signal 120 in a best possible manner. For example, it would also be possible to translate the de-emotionalized speech signal 120 into a foreign language, which is the native tongue of the user. Additionally, the de-emotionalized speech signal can be reproduced in simplified language, which can improve the comprehension of the speech signal 110 for the user.

One example how simplified language can be generated based on the emotional speech material and the emotions but also intonations (or emphasis in the pronunciation) are used to reproduce the same in simplified language is the following: when somebody speaks in a very furious manner and delivers the speech signal 110 “you can't say that to me”, the speech signal 110 would, for example, be replaced by the following de-emotionalized speech signal 120: “I am very furious as you can't say that to me”. In that case, the processing apparatus 30 would transcribe the emotion information 12 according to which the speaker is “very furious” into the further word information 14′ “I am furious”.

The processing apparatus 30 includes a neuronal network, which is configured to transcribe the emotion information 12 based on the training data or based on a rule-based transcription into further word information 14′. One option of using a neuronal network would be an end-to-end transcription. In a rule-based transcription, for example, the content of a dictionary can be used. When using artificial intelligence, the same can learn the needs of the user based on training data predetermined by the user.

The speech signal processing apparatus 100 is configured to use a first and/or second piece of context information to detect current location coordinates of the speech signal processing apparatus 100 based on the first piece of context information and/or to set, based on the second piece of context information, associated pre-settings for transcription at the speech signal processing apparatus 100. The speech signal processing apparatus 100 can include a GPS unit (not shown in the figures) and/or a speaker recognition system, which is configured to detect current location coordinates of the speech signal processing apparatus 100, and/or to recognize the speaker expressing the speech signal 110 and to set, based on the detected current location coordinates and/or speaker information, associated pre-settings for transcribing at the speech signal processing apparatus 100. The first piece of context information can include detecting the current location coordinates of the speech signal processing apparatus 100. The second piece of context information can include identifying a speaker. The second piece of context information can be detected with the speaker recognition system. After identifying a speaker, processing the speech signal 110 can be adapted to the identified speaker, in particular pre-settings associated with the identified speaker can be adjusted to process the speech signal 110. The pre-settings can include, for example, an allocation of different voices for different speakers in the case of speech synthesis or very strong de-emotionalization at school, but less strong de-emotionalization of the speech signal 110 at home. Thus, when processing speech signals 110, the speech signal processing apparatus 100 can use additional, in particular first and/or second pieces of context information, such as position data like GPS that indicate the current location or a speaker recognition system identifying a speaker and adapting the processing in a speaker-dependent manner. When identifying different speakers, it is possible that different voices are associated to the different speakers by the speech signal processing apparatus 100. This can be advantageous in the case of speech synthesis or for a very strong de-emotionalization at school, particularly due to the prevailing background sound by other students. In a home environment, however, it can be possible that less de-emotionalization of the speech signal 110 is needed.

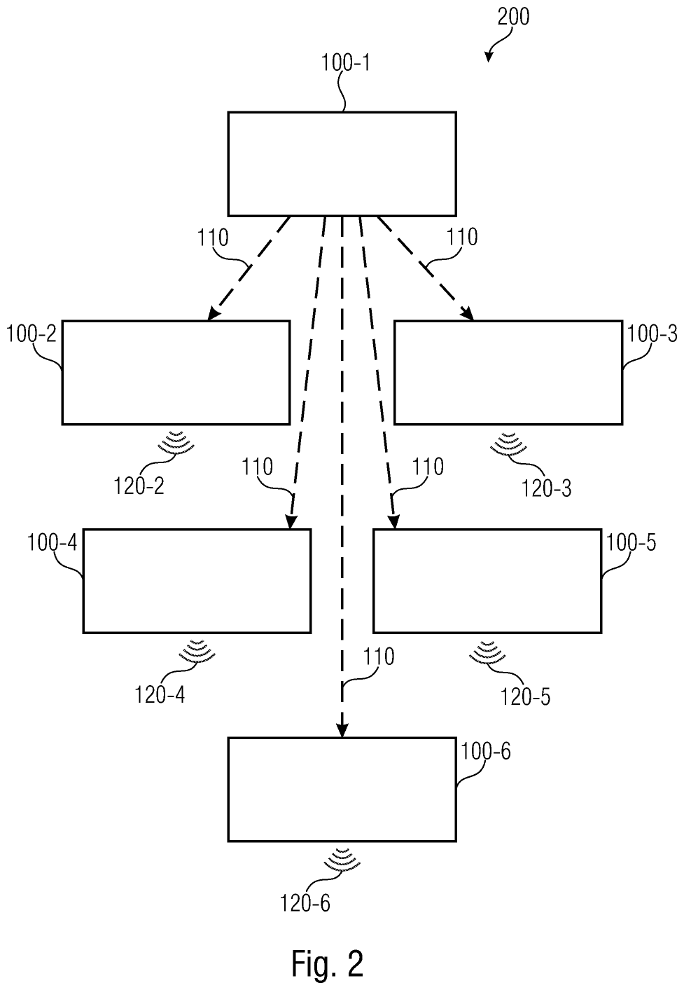

In particular, the speech signal processing apparatus 100 includes a signal exchange unit (only indicated in FIG. 2 by the dotted arrows) that is configured to perform signal transmission of a detected speech signal 110 with one or several other speech signal processing apparatuses 100-1 to 100-6, in particular by means of radio or Bluetooth or LiFi (Light Fidelity). The signal transmission can take place from point to multipoint (see FIG. 2). Then, each of the speech signal processing apparatuses 100-1 to 100-6 can then reproduce a de-emotionalized signal 120-1, 120-2, 120-3, 120-4, 120-5, 120-6 that is in particular adapted to the needs of the respective user. In other words, one and the same detected speech signal 110 can be transcribed into a different de-emotionalized signal 120-1 to 120-6 by each of the speech signal processing apparatuses 100-1 to 100-6. In FIG. 2, the transmission of the speech signal 110 is shown in a unidirectional manner. Such unidirectional transmission of the speech signal 110 is, for example, suitable at school. It is also possible that speech signals 110 can be transmitted in a bidirectional manner between several speech signal processing apparatuses 100-1 to 100-6. Thereby, for example, communication between the users of the speech signal processing apparatuses 100-1 to 100-6 can be made easier.

The speech signal processing apparatus 100 comprises a user interface 70 that is configured to divide the at least one piece of emotion information 12 according to preferences set by the user into an undesired piece of emotion information and/or as a neutral piece of emotion information and/or a positive piece of emotion information. The user interface is connected to each of the apparatuses 10, 20, 30, 40, 50, 60 in a communicative manner. Thereby, each of the apparatuses 10, 20, 30, 40, 50, 60 can be controlled by the user via the user interface 70 and possibly a user input can be made.

For example, the speech signal processing apparatus 100 is configured to categorize the at least one detected piece of emotion information 12 into classes of different disturbance quality, in particular those having, for example, the following allocation: Class 1 “very disturbing”, Class 2 “disturbing”, Class 3 “less disturbing” and Class 4 “not disturbing at all”; and to reduce or suppress the at least one detected piece of emotion information 12 that has been categorized into one of Class 1 “very disturbing” or Class 2 “disturbing” and/or to add the at least one detected emotion information 12 that has been categorized in one of Class 3 “less disturbing” or Class 4 “not disturbing at all” to the de-emotionalized speech signal 120 and/or to add a generated piece of emotion information 12′ to the de-emotionalized signal 120 to support comprehension of the de-emotionalized speech signal 120 for a user. Other forms of detections are also possible. Here, the example is merely to indicate a possibility how emotion information 12 could be classified. Further, it should be noted that here a generated piece of emotion information 12′ corresponds to an impressed piece of emotion information 12′. It is further possible to categorize detected emotion information 12 into more or less than four classes.

The speech signal processing apparatus 100 comprises a sensor 80 that is configured to identify undesired and/or neutral and/or positive emotion signals for the user during contact with a user. In particular, the sensor 80 is configured to measure bio signals, such as to perform a neurophysiological measurement or to capture and evaluate an image of a user. The sensor can be implemented by a camera or video system by which the user is captured in order to analyze his or her mimics with respect to a speech signal 110 perceived by the user. The sensor can be considered as a neuro interface. In particular, the sensor 80 is configured to measure the blood pressure, the skin conductance value or the same. In particular, actively marking undesired emotion information by the user is possible when, for example, the sensor 80 detects an increase in blood pressure of the user during an undesired piece of emotion information 12. Further, the sensor 12 can also determine a positive piece of emotion information 12 for the user, namely in particular when the blood pressure measured by the sensor 80 does not change during the piece of emotion information 12. The information on positive or neutral pieces of emotion information 12 can possibly provide important input quantities for processing the speech signal 112 or for training the analysis apparatus 20 or for the synthesis of a de-emotionalized speech signal 120, etc.

The speech signal processing apparatus 100 includes a compensation apparatus 90 that is configured to compensate an individual hearing impairment associated with the user in particular by non-linear and/or frequency-dependent amplification of the de-emotionalized speech signal 120. Due to an amplification of the de-emotionalized speech signal 120, in particular in a non-linear and/or frequency-dependent manner, the de-emotionalized speech signal 120 can still be acoustically reproduced for the user despite an individual hearing impairment.

FIG. 2 shows a speech signal reproduction system 200 including two or more speech signal processing apparatuses 100-1 to 100-6 as described herein. Such a speech signal reproduction system 200 could be applied for example, during teaching at a school. For example, a teacher could talk into the speech signal processing apparatus 100-1 that detects the speech signals 110. Then, via the coupling apparatus 40 (see FIG. 1) of the speech signal processing apparatus 100-1, a connection could be established, in particular to the respective coupling apparatus of the speech signal processing apparatuses 100-2 to 100-6, which transmits the detected speech signal(s) 110 simultaneously to the speech signal processing apparatuses 100-2 to 100-6. Then, each of the speech signal processing apparatuses 100-2 to 100-6 can analyze the received speech signal 110 as described above and transcribe the same into a de-emotionalized signal 120 in a user-individual manner and to reproduce the same for the users. Speech signal transmission from one speech signal processing apparatus 100-1 to another speech signal processing apparatus 100-2 to 100-6 can take place via radio, Bluetooth, LiFi etc.

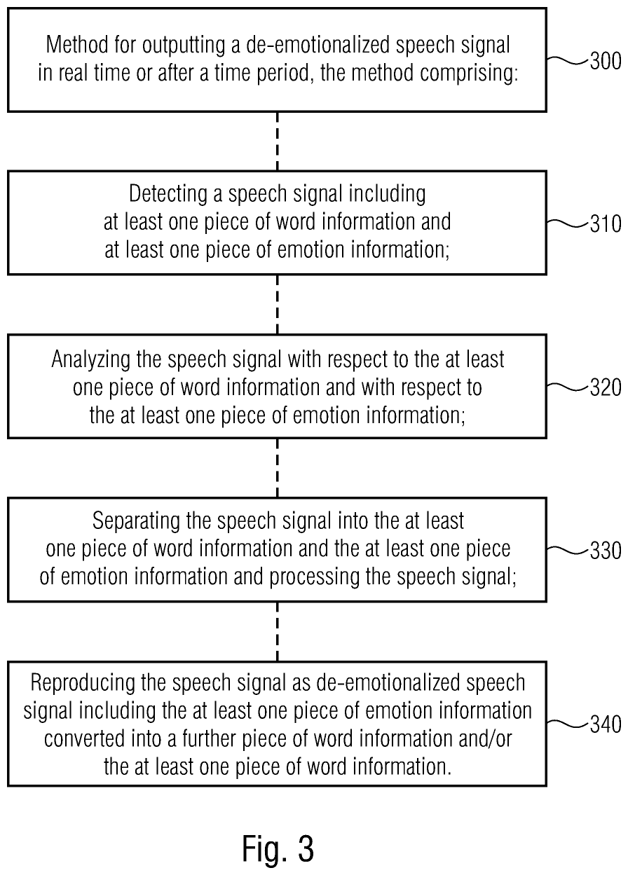

FIG. 3 shows a method 300 for outputting a de-emotionalized speech signal 120 in real time or after time period. The method 300 includes a step 310 of detecting a speech signal 110 including at least one piece of word information 14 and at least one piece of emotion information 12. The piece of emotion information 12 includes at least one suprasegmental feature that can be transcribed into a further piece of word information 14′ or that can be subtracted from the speech signal 110. In any case, a de-emotionalized signal 120 results. The speech signal to be detected can be language of a person spoken in situ or can be generated by a media file, by radio or by video that is replayed.

In the subsequent step 320, the speech signal 110 is analyzed with respect to the at least one piece of word information 14 and with respect to the at least one piece of emotion information 12. For this, an analysis apparatus 30 is configured to detect which speech signal portion of the detected speech 110 is to be allocated to a piece of word information 14 and which speech signal portion of the detected speech signal 110 is to be allocated to a piece of emotion information 12, i.e. in particular to an emotion.

After the step 320 of analyzing, step 330 follows. Step 330 includes dividing the speech signal 110 into the at least one piece of word information 14 and into the at least one piece of emotion information 14 and processing the speech signal 110. For this, a processing apparatus 40 can be provided. The processing apparatus can be integrated in the analysis apparatus 30 or can be an apparatus independent of the analysis apparatus 30. In any case, the analysis apparatus 30 and the processing apparatus are coupled, such that after the analysis with respect to the word information 14 and the emotion information 12, these two pieces of information 12, 14 are divided into two signals. The processing apparatus is further configured to translate or transcribe the emotion information 12, i.e., the emotion signal into a further piece of word information 14′. Additionally, the processing apparatus 40 is configured to alternatively remove the emotion information 12 from the speech signal 110. In any case, the processing apparatus is configured to turn the speech signal 110, which is a sum or super position of the word information 14 and the emotion information 12, into a de-emotionalized speech signal 120. The de-emotionalized speech signal 120 includes only, in particular, first and second pieces of word information 14, 14′ or pieces of word information 14, 14′ and one or several pieces of emotion information 12, which have been classified as allowable, in particular acceptable or non-disturbing by a user.

Last, there is a step 340, according to which the speech signal 110 is reproduced as de-emotionalized speech signal 120 which includes the at least one piece of emotion information 12 converted into a further piece of word information 14′ and/or includes the at least one piece of word information 14.

With the suggested method 300 or with the suggested speech signal reproduction apparatus 100, a speech signal 110 detected in situ can be reproduced for the user as de-emotionalized speech signal 120 in real time or after a time period, i.e., at a later time, which has the consequence that the user, who could otherwise have problems in understanding the speech signal 110, can understand the de-emotionalized speech signal 120 essentially without any problems.

The method 300 includes storing the de-emotionalized speech signal 120 and/or the detected speech signal 110; and reproducing the de-emotionalized speech signal 120 and/or the detected speech signal 120 at any time. When storing the speech signal 110, for example, the word information 14 and the emotion information 12 are stored, wherein storing the de-emotionalized speech signal 120, for example, the word information 14 and the emotion signal 12 transcribed into further word information 14′ are stored. For example, a user or another person can have the speech signal 110 reproduced, and particularly listen to the same and can compare the same with the de-emotionalized speech signal 120. For the case that the emotion information has not been transcribed in an exactly suitable manner into a further piece of word information 14′, the user or the further person can change and in particular correct the transcribed further piece of word information 14′. When using artificial intelligence (AI), the correct transcription of a piece of emotion information 12 into a piece of further word information 14′ for a user can be learned. AI can, for example, also learn which emotion information 12 do not disturb the user or even touch him in a positive manner or seem to be neutral for a user.

The method 300 includes recognizing the at least one piece of emotion information 12 in the speech signal 110; and analyzing the at least one piece of emotion information 12 with respect to possible transcriptions of the at least one emotion signal 12 in n different further, in particular, second pieces of word information 14′, wherein n is a natural number greater than or equal to 1 and n indicates a number of options of transcribing the at least one piece of emotion information 12 appropriately into the at least one further word information 14′; and transcribing the at least one piece of emotion information 12 into the n different further pieces of word information 14′. For example, a content-changing SF in a speech signal 110 can be transcribed into n differently changed contents. For example: The sentence “Are you driving to Oldenburg today?” can be understood differently, depending on the emphasis. If “Are you driving” is emphasized, an answer like, for example, “No, I am flying to Oldenburg”, would be expected, if, however, “you” is emphasized, an answer like “No, not I am driving to Oldenburg but a colleague” would be expected. In the first case, a transcription could be “you will be in Oldenburg today, will you be driving there?”. Depending on the emphasis, different second pieces of word information 14′ can result from a single piece of emotion information 12.

The method 300 includes identifying undesired and/or neutral and/or positive emotion information by a user by means of a user interface 70. The user of the speech signal processing apparatus 100 can define, for example via the user interface 70, which emotion information 12 he or she finds disturbing, neutral or positive. For example, emotion information 12 considered as disturbing can be treated as emotion information that has to be transcribed, while emotion information 12 considered to be positive or neutral can remain in the de-emotionalized speech signal 120 in an unamended manner.

The method 300 further or alternatively includes identifying of undesired and/or neutral and/or positive emotion information 12 by means of a sensor 80 that is configured to perform a neurophysiological measurement. Thus, the sensor 80 can be a neuro interface. The neuro interface is only stated as an example. Further, it is possible to provide other sensors. For example, one sensor 80 or several sensors 80 could be provided that are configured to detect different measurement quantities, in particular blood pressure, heart rate and/or skin conductance value of the user.

The method 300 can include categorizing the at least one detected piece of emotion information 12 into classes having different disturbing qualities, in particular wherein the classes could have, for example, the following allocation: Class 1 “very disturbing”, Class 2 “disturbing”, Class 3 “less disturbing” and Class 4 “not disturbing at all”. Further, the method can include reducing or suppressing the at least one detected piece of emotion information 12 that has been categorized in one of the Classes 1 “very disturbing” or Class 2 “disturbing” and/or adding the at least one detected piece of emotion information 12 that has been categorized in one of the Classes 3 “less disturbing” or Class 4 “not disturbing at all” to the de-emotionalized speech signal and/or adding a generated piece of emotion information 12′ to support comprehension of the de-emotionalized speech signal 120 for a user. Thus, a user can adapt the method 300 to his or her individual needs.

The method 300 includes reproducing the de-emotionalized speech signal 120, in particular in simplified language by an artificial voice and/or by indicating a computer-written text and/or by generating and displaying picture card symbols and/or by animation of sign language. Here, the de-emotionalized speech signal 120 can be reproduced to the user in a manner adapted to his or her individual needs. The above list is not exhaustive. Rather, many different types of reproduction are possible. Thereby, the speech signal 110 can be reproduced in simplified language, in particular in real time. The detected, in particular recorded speech signals 100 can be replaced, for example, by an artificial voice after transcribing into a de-emotionalized speech signal 120, wherein the voice includes no or only reduced SF portions or no longer includes the SF portions that have individually been identified as particularly disturbing. For example, the same voice could be reproduced for a person with autism even when the voice originates from different dialog partners (e.g., different teachers), if this corresponds to the individual needs of communication.

For example, the sentence “In a commotion that continually increased, people held up posters saying “no violence”, but the policemen hit them with batons” could be transcribed into simple language as follows: “The commotion increased. People held up posters saying “no violence”. Policemen hit them with batons”.

The method 300 includes compensating an individual hearing impairment associated with the user, in particular non-linear and/or frequency-dependent amplification of the de-emotionalized speech signal 120. Therefore, the user can be provided with a hearing experience as long as the de-emotionalized speech signal 120 is acoustically reproduced for the user, which is similar to a hearing experience of a user having no hearing impairment.

The method 300 includes analyzing whether a disturbing noise, in particular individually defined by the user, is detected in the detected speech signal 110 and possibly subsequently removing the detected disturbing noise. Disturbing noises can be, for example, background noises such as a barking dog, other people, traffic noise, etc. As long as the speech or the disturbing noise are not manipulated directly, but the speech is generated “artificially” (i.e., for example in an end-to-end method), in this context disturbing noises are automatically removed. Aspects like an individual or subjective improvement of clarity, pleasantness or familiarity can be considered during training or can be subsequently impressed.

The method 300 includes detecting a current location coordinate by means of GPS, whereupon adjusting pre-settings associated with the detected location coordinate for transcription of speech signals 110 detected at the current location coordination takes place. Due to the fact that a current location can be detected, such as the school or the own home or a supermarket, pre-settings associated with the respective location and the transcription of detected speech signals 110 related to the respective location can be automatically changed or adapted.

The method 300 includes transmitting a detected speech signal 110 from a speech signal processing apparatus 100, 100-1 to another speech signal processing apparatus 100 or to several speech signal processing apparatuses 100, 100-2 to 100-6 by means of radio or Bluetooth or LiFi (Light Fidelity). When using LiFi, signals could be transmitted in a direct or indirect field of view. For example, a speech signal processing apparatus 100 could transmit a speech signal 110, in particular in an optical manner, to a control interface where the speech signal 110 is routed to different outputs and distributed to the speech signal processing apparatus 100, 100-2 to 100-6 at the different outputs. Each of the different outputs can be communicatively coupled to a speech signal processing apparatus 100.

A further aspect of the present application relates to a computer-readable storage medium, including instructions prompting, when executed by a computer, in particular, a speech signal processing apparatus 100, the same to perform the method as described herein. In particular, the computer, in particular the speech signal processing apparatus 100, can be implemented by a smartphone, a tablet, a smartwatch, etc.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be performed by a hardware apparatus (or using a hardware apparatus), such as a microprocessor, a programmable computer or an electronic circuit. In some embodiments, some or several of the most important method steps may be performed by such an apparatus.

In the preceding detailed description, various features have been grouped together in examples in part to streamline the disclosure. This type of disclosure should not be interpreted as intending that the claimed examples have more features than are explicitly stated in each claim. Rather, as the following claims reflect, subject matter may be found in fewer than all of the features of a single disclosed example. Consequently, the following claims are hereby incorporated into the detailed description, and each claim may stand as its own separate example. While each claim may stand as its own separate example, it should be noted that although dependent claims in the claims refer back to a specific combination with one or more other claims, other examples also include a combination of dependent claims with the subject matter of any other dependent claim or a combination of any feature with other dependent or independent claims. Such combinations are encompassed unless it is stated that a specific combination is not intended. It is further intended that a combination of features of a claim with any other independent claim is also encompassed, even if that claim is not directly dependent on the independent claim.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may, for example, be stored on a machine-readable carrier.

Other embodiments comprise the computer program for performing one of the methods described herein, wherein the computer program is stored on a machine-readable carrier. In other words, an embodiment of the inventive method is, therefore, a computer program comprising a program code for performing one of the methods described herein, when the computer program runs on a computer.

A further embodiment of the inventive method is, therefore, a data carrier (or a digital storage medium or a computer-readable medium) comprising, recorded thereon, the computer program for performing one of the methods described herein. The data carrier, the digital storage medium, or the computer-readable medium are typically tangible or non-volatile.

A further embodiment of the inventive method is, therefore, a data stream or a sequence of signals representing the computer program for performing one of the methods described herein. The data stream or the sequence of signals may be configured, for example, to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment in accordance with the invention includes an apparatus or a system configured to transmit a computer program for performing at least one of the methods described herein to a receiver. The transmission may be electronic or optical, for example. The receiver may be a computer, a mobile device, a memory device or a similar device, for example. The apparatus or the system may include a file server for transmitting the computer program to the receiver, for example.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A speech signal processing apparatus for outputting a de-emotionalized speech signal in real time or after a time period, the speech signal processing apparatus comprising:
a speech signal detection apparatus for detecting a speech signal including at least one piece of emotion information and at least one piece of word information;
an analysis apparatus for analyzing the speech signal with respect to the at least one piece of emotion information and the at least one piece of word information,
a processing apparatus for dividing the speech signal into the at least one piece of word information and into the at least one piece of emotion information and for processing the speech signal; and
a coupling apparatus and/or a reproduction apparatus for reproducing the speech signal as de-emotionalized speech signal including the at least one piece of emotion information converted into a further piece of word information and/or the at least one piece of word information.

2. The speech signal processing apparatus according to claim 1 comprising a storage apparatus storing the de-emotionalized speech signal and/or the detected speech signal to reproduce the de-emotionalized speech signal at any time, in particular to reproduce the stored speech signal at more than a single arbitrary time as a de-emotionalized speech signal.

3. The speech signal processing apparatus according to claim 1, wherein the processing apparatus is configured to recognize the further piece of word information comprised in the emotion information and to translate the same into a de-emotionalized speech signal and to forward the same to the reproduction apparatus for reproduction by the reproduction apparatus or to the coupling apparatus that is configured to connect to an external reproduction apparatus, in particular a smartphone or a tablet, to transmit the de-emotionalized signal for reproduction of the same.

4. The speech signal processing apparatus according to claim 1, wherein the analysis apparatus is configured to analyze a disturbing noise and/or a piece of emotion information in the speech signal and the processing apparatus is configured to remove the analyzed disturbing noise and/or the piece of emotion information from the speech signal.

5. The speech signal processing apparatus according to claim 1, wherein the reproduction apparatus is configured to reproduce the de-emotionalized speech signal without the piece of emotion information or with the piece of emotion information that has been transcribed into the further piece of word information and/or with a newly impressed piece of emotion information.

6. The speech signal processing apparatus according to claim 1, wherein the reproduction apparatus comprises a loudspeaker and/or a display to reproduce the de-emotionalized speech signal, in particular in simplified language, by an artificial voice and/or by displaying a computer-written text and/or by generating and displaying picture card symbols and/or by animation of sign language.

7. The speech signal processing apparatus according to claim 1, wherein the analysis apparatus comprises a neuronal network that is configured to transcribe the piece of emotion information into the further piece of word information based on training data or based on a rule-based transcription.

8. The speech signal processing apparatus according to claim 1, wherein the speech signal processing apparatus comprises a GPS unit and/or a speaker recognition system configured to detect a current location coordinate of the speech signal processing apparatus and/or to recognize the speaker providing the speech signal and to adjust, based on the detected current location coordinate and/or speaker information, associated pre-settings for transcription at the speech signal processing apparatus.

9. The speech signal processing apparatus according to claim 1 comprising signal exchange means configured to perform a signal transmission of a detected speech signal with one or several other speech signal processing apparatuses, in particular via radio or Bluetooth or LiFi (Light Fidelity).

10. The speech signal processing apparatus according to claim 1 comprising an operating interface configured to divide the at least one piece of emotion information according to preferences set by a user into an undesired piece of emotion information and/or into a neutral piece of emotion information and/or into a positive piece of emotion information.

11. The speech signal processing apparatus according to claim 10 that is configured to categorize the at least one detected piece of emotion information into classes of different disturbing qualities, in particular those comprising the following allocation: Class 1 “very disturbing”, Class 2 “disturbing”, Class 3 “less disturbing”, Class 4 “not disturbing at all” and
to reduce or suppress the at least one detected piece of emotion information that has been categorized in one of the Classes 1 “very disturbing” or Class 2 “disturbing” and/or
to add the at least one detected piece of emotion information that has been categorized into one of the Classes 3 “less disturbing” or Class 4 “not disturbing at all” to the de-emotionalized speech signal and/or
to add a generated piece of emotion information to the de-emotionalized signal in order to support comprehension of the de-emotionalized speech signal by a user.

12. The speech signal processing apparatus according to claim 1 comprising a sensor that is configured, when in contact with a user, to identify undesired and/or mutual and/or positive emotion information for the user, wherein the sensor is configured to measure bio signals, such as to perform a neurophysiological measurement or to capture and evaluate an image of a user.

13. The speech signal processing apparatus according to claim 1 comprising a compensation apparatus that is configured to compensate an individual hearing impairment associated with a user by non-linear and/or frequency-dependent amplification of the de-emotionalized speech signal.

14. The speech signal reproduction system comprising two or more speech signal processing apparatuses according to claim 1.

15. A method for outputting a de-emotionalized speech signal in real time or after a time period, the method comprising:
detecting a speech signal comprising at least one piece of word information and at least one piece of emotion information;
analyzing the speech signal with respect to the at least one piece of word information and with respect to the at least one piece of emotion information;
dividing the speech signal into the at least one piece of word information and into the at least one piece of emotion information and processing the speech signal;
reproducing the speech signal as de-emotionalized speech signal comprising the at least one piece of emotion information converted into a further piece of word information and/or comprising the at least one piece of word information.

16. The method according to claim 15, comprising:
storing the de-emotionalized speech signal and/or the detected speech signal;
reproducing the de-emotionalized speech signal and/or the detected speech signal at any time.

17. The method according to claim 15, comprising:
detecting the at least one piece of emotion information in the speech signal;
analyzing the at least one piece of emotion information with respect to possible transcriptions of the at least one piece of emotion signal into n different further pieces of word information, wherein n is a natural number greater than or equal to 1 and n indicates the number of options of appropriately transcribing the at least one piece of further emotion information into the at least one further piece of word information;
transcribing the at least one piece of emotion information into the n different further pieces of word information.

18. The method according to claim 15, comprising:
identifying undesired and/or neutral and/or positive emotion information by a user by means of an operating interface.

19. The method according to claim 15, comprising:
identifying undesired and/or neutral and/or positive emotion information by means of a sensor, in particular configured to measure bio signals, such as to perform a neurophysiological measurement or to capture and evaluate an image of a user.

20. The method according to claim 18, comprising:
categorizing the at least one detected piece of emotion information into classes of different disturbing quality, in particular those comprising at least one of the following allocations: Class 1 “very disturbing”, Class 2 “disturbing”, Class 3 “less disturbing” and Class 4 “not disturbing at all”;
reducing or suppressing the at least one detected piece of emotion information that has been categorized into one of the Classes 1 “very disturbing” or Class 2 “disturbing” and/or
adding the at least one detected piece of emotion information that has been categorized into one of the Classes 3 “less disturbing” or Class 4 “not disturbing at all” to the de-emotionalized speech signal and/or
adding a generated piece of emotion information to support comprehension of the de-emotionalized speech signal by a user.

21. The method according to claim 15, comprising:
reproducing the de-emotionalized speech signal in particular in simplified language,
by an artificial voice and/or
by display of a computer written text and/or
by generating and displaying picture card symbols and/or
by animation of sign language.

22. The method according to claim 15, comprising:
compensating an individual hearing impairment associated with a user in particular by non-linear and/or frequency-dependent amplification of the de-emotionalized speech signal.

23. The method according to claim 15, comprising:
analyzing whether a disturbing noise, in particular one defined individually by a user is detected in the detected speech signal,
removing the detected disturbing noise.

24. The method according to claim 15, comprising:
detecting a current location coordinate by means of GPS,
adjusting pre-settings associated with the detected location coordinate for transcription of speech signals detected at the current location coordinate.

25. The method according to claim 15, comprising:
transmitting a detected speech signal from a speech signal processing apparatus to another speech signal processing apparatus or to several speech signal processing apparatuses by means of GPS or radio or Bluetooth or LiFi (Light Fidelity).

26. A non-transitory digital storage medium having a computer program stored thereon to perform the method for outputting a de-emotionalized speech signal in real time or after a time period, the method comprising:
detecting a speech signal comprising at least one piece of word information and at least one piece of emotion information;
analyzing the speech signal with respect to the at least one piece of word information and with respect to the at least one piece of emotion information;
dividing the speech signal into the at least one piece of word information and into the at least one piece of emotion information and processing the speech signal;
reproducing the speech signal as de-emotionalized speech signal comprising the at least one piece of emotion information converted into a further piece of word information and comprising the at least one piece of word information,
when said computer program is run by a computer.

27. A speech signal processing apparatus for outputting a de-emotionalized speech signal, the speech signal processing apparatus comprising:
a speech signal detection apparatus configured to detect a speech signal comprising at least one piece of emotion information and at least one piece of word information;
an analysis apparatus comprising a neuronal network or artificial intelligence configured to analyze the speech signal with respect to the at least one piece of emotion information and the at least one piece of word information,
a processing apparatus comprising a neuronal network or artificial intelligence configured to divide the speech signal into the at least one piece of word information and into the at least one piece of emotion information and to process the speech signal, wherein the at least one piece of emotion information is transcribed into a further piece of word information; and
a coupling apparatus and/or a reproduction apparatus configured to reproduce the speech signal as de-emotionalized speech signal comprising the at least one piece of emotion information converted into the further piece of word information and the at least one piece of word information.
